(19) United States
(12) Patent Application Publication
(10) Pub. No.: US 2019/0378071 A1
(43) Pub. Date: Dec. 12, 2019

(54) PRIORITIZED LIST OF WORK TASKS

(71) Applicants: Bing XU, Shanghai (CN); HEWLETT PACKARD ENTERPRISE DEVELOPMENT LP, Fort Collins, CO (US)

(72) Inventor: Bing Xu, Shanghai (CN)

(21) Appl. No.: 16/478,860

(22) PCT Filed: Feb. 23, 2017
(86) PCT No.: PCT/CN2017/074553

§ 371 Date: Jul. 18, 2019

(51) Int. Cl. G06Q 10/06; G06F 9/48; G06F 9/38; G06F 17/18

(52) U.S. Cl. CPC G06Q 10/06316; G06F 17/18; G06F 9/3855; G06F 9/4881

(57) ABSTRACT

A computing device includes a processor and a machine-readable storage medium storing instructions. The instructions are executable by the processor to: determine a first plurality of priority scores for a plurality of work tasks; determine a first prioritized list of work tasks based on the first plurality of priority scores; detect a plurality of user selections from the first prioritized list of work tasks; determine a second plurality of priority scores using a regression analysis of the plurality of user selections from the first prioritized list of work tasks; and determine a second prioritized list of work tasks based on the second plurality of priority scores.

### BACKGROUND

Some individuals or organizations may perform work as a series of tasks. For example, an information technology (IT) help desk may receive multiple requests for help from customers. The IT help desk may use a task or ticket system to manage the tasks associated with the received requests.

### BRIEF DESCRIPTION OF THE DRAWINGS

Some implementations are described with respect to the following figures.

FIG. 1 is a schematic diagram of an example system, in accordance with some implementations.

FIG. 2 is an illustration of an example task list operation in accordance with to some implementations.

FIG. 3 is an illustration of an example priority profile in accordance with some implementations.

FIG. 4 is a flow diagram of an example process for prioritizing a list of work tasks in accordance with some implementations.

FIG. 5 is a schematic diagram of an example computing device in accordance with some implementations.

FIG. 6 is an illustration of an example machine-readable storage medium storing instructions in accordance with some implementations.

FIG. 7 is a flow diagram of an example process for prioritizing a list of work tasks in accordance with some implementations.

### DETAILED DESCRIPTION

Some organizations may use management software to schedule and track a series of work tasks. For example, an information technology (IT) help desk organization may open a work task or ticket for each request for help that is received from a customer. A user (e.g., a help desk analyst) may interact with the management software to access a list of work tasks that are assigned to the user. In some examples, the list may indicate a sequential order in which the user can complete the work tasks. However, in some examples, the order indicated by the list may be based on a simple rule or algorithm (e.g., according to time of receipt), and may not reflect the relative importance of each task in view of multiple priority factors of the user and/or organization. Thus, such lists may not provide sufficiently accurate and/or useful information for the user to perform the assigned tasks in order.

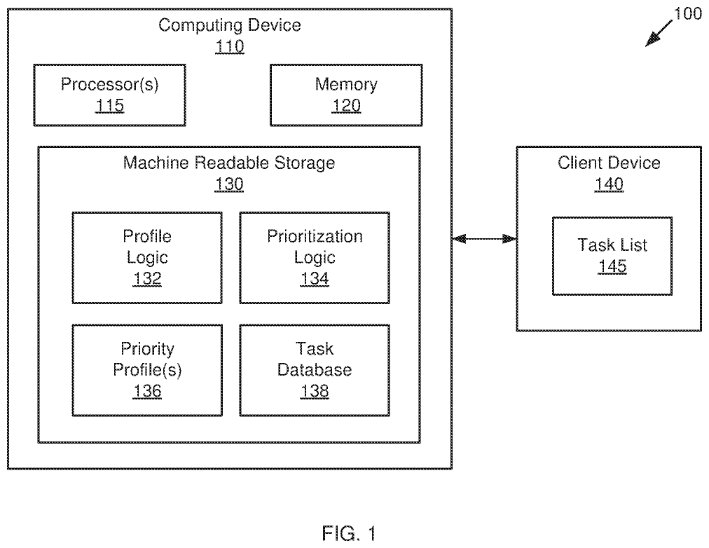

In accordance with some implementations, examples are provided for generating prioritized lists of work tasks. As described further below with reference to FIGS. 1-7, some implementations include determining priority scores for work tasks, and determining a prioritized list of work tasks based on the priority scores. Each priority score may be based on a set of weights for multiple priority factors. Some implementations may include receiving user selections from the prioritized list of work tasks, and determining a second set of priority scores using a regression analysis of the user selections. The second set of priority scores may be used to determine a second prioritized list of work tasks. In some implementations, the second set of priority scores may reflect the subjective importance of each priority factor for the user. As such, some implementations may provide accurate and/or useful prioritization of the list of work tasks.

FIG. 1 is a schematic diagram of an example system 100, in accordance with some implementations. In some examples, the system 100 may include a computing device 110 and a client device 140. The computing device 110 may be, for example, a computer, a portable device, a server, a network device, a communication device, etc. Further, the computing device 110 may be any grouping of related or interconnected devices, such as a blade server, a computing cluster, and the like. Furthermore, in some implementations, the computing device 110 may be a dedicated device or appliance for managing work tasks.

In some implementations, the computing device 110 can interface with the client device 140. For example, the client device 140 may be a terminal or computer that is connected to the computing device via a wired or wireless network. In other examples, the client device 140 may comprise a display screen coupled to (or included in) the computing device 110. As shown, in some implementations, the client device 140 may display or output a task list 145 to a user (not shown). In some implementations, the task list 145 may include work tasks to be completed by a particular entity (e.g., an individual, a work role, an organization, etc.).

As shown, the computing device 110 can include processor(s) 115, memory 120, and machine-readable storage 130. The processor(s) 115 can include a microprocessor, microcontroller, processor module or subsystem, programmable integrated circuit, programmable gate array, multiple processors, a microprocessor including multiple processing cores, or another control or computing device. The memory 120 can be any type of computer memory (e.g., dynamic random access memory (DRAM), static random-access memory (SRAM), etc.).

In some implementations, the machine-readable storage 130 can include non-transitory storage media such as hard drives, flash storage, optical disks, etc. As shown, the machine-readable storage 130 can include profile logic 132, prioritization logic 134, priority profiles 136, and a task database 138.

As shown in FIG. 1, in some implementations, the profile logic 132 and/or the prioritization logic 134 may be implemented as instructions stored in the machine-readable storage 130. However, the profile logic 132 and/or the prioritization logic 134 can be implemented in any suitable manner. For example, some or all of the profile logic 132 and/or the prioritization logic 134 could be hard-coded as circuitry included in the processor(s) 115 and/or the computing device 110. In other examples, some or all of the profile logic 132 and/or the prioritization logic 134 could be implemented on a remote computer (not shown), as web services, and so forth. In another example, the profile logic 132 and/or the prioritization logic 134 may be implemented in one or more controllers of the computing device 110.

In some implementations, the task database 138 may include a set of current work tasks that require completion. For example, the task database 138 may store open tickets of an IT support organization. In some implementations, each work task in the task database 138 may be associated with multiple factor values. The factor values may characterize a particular work task in terms of multiple priority factors. For example, each factor value may be a number indicating a level or score of a work task with respect to a particular priority factor. In some implementations, the factor values may correspond to priority factors such as task urgency, level of business impact, response time specified in a Service Level Agreement (SLA), level of financial loss, importance level of a task requester (e.g., a very important person (VIP) level), time duration since receipt of a task request, and so forth. In some implementations, some or all of the factor values of a work task may be automatically determined based on characteristics of the work task (e.g., time received, client identifier, business process identifier, and so forth). Further, in some implementations, some or all of the factor values of a work task may be manually specified by a human user or administrator.

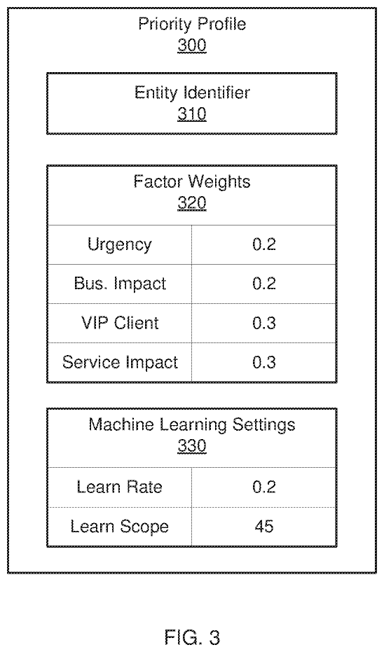

In some implementations, the profile logic 132 can generate a priority profile 136 for a particular entity. The priority profile 136 may include information indicating the relative importance of various priority factors for the particular entity. In some implementations, the priority profile 136 may include weight values (“factor weights”) to indicate the relative importance of each priority factor. An example implementation of the priority profile 136 is discussed below with reference to FIG. 3.

In some implementations, the profile logic 132 may generate a priority profile 136 based on the user context of an entity. For example, a user context may specify that a person in a. given role or organization (e.g., IT help desk, support technician, analyst, etc.) is associated with a default set of factor weights. As such, in some implementations, the profile logic 132 may determine the default set of factor weights for an individual in that role, and may generate a priority profile 136 to include that default set of factor weights.

In some implementations, an entity may be associated with multiple priority profiles 136. Such priority profiles 136 may have a hierarchical structure with inheritance of values. For example, assume that a user is assigned to a help desk role in an IT organization. Assume further that a first priority profile 136 is associated with the IT organization, a second priority profile 136 is associated with the help desk role, and that a third priority profile 136 is specific to the user. In this example, the second priority profile 136 may inherit default factor weights from the first priority profile 136. Similarly, the third priority profile 136 may inherit default factor weights from the first priority profile 136. In some implementations, the prioritization logic 134 may use predefined rules to resolve conflicts between conflicting factor weights inherited by a given priority profile 136 (e.g., use the most recent setting, use the value manually set by the user, use the value specified for lowest level of hierarchy, and so forth).

In some implementations, the prioritization logic 134 may generate the task list 145 using the task database 138. For example, in some implementations, the prioritization logic 134 may interact with the task database 138 to identify a set of work tasks assigned to a particular user. The prioritization logic 134 may then generate the task list 145 using some or all of the identified set of work tasks. For example, the prioritization logic 134 may create the task list 145 by filtering the identified set of work tasks to a defined number of tasks, to a defined time period, to a defined amount of work, and so forth.

In some implementations, the prioritization logic 134 may prioritize the task list 145 using the priority profile 136. For example, in some implementations, the prioritization logic 134 may interact with the task database 138 to access the factor values associated with each work task in the task list 145. Further, the prioritization logic 134 may interact with the priority profile 136 of the user to access the factor weight for each factor.

In some implementations, the prioritization logic 134 may determine, for each factor of each work task, a weighted value based on the factor value and the factor weight. For example, assume that the priority profile 136 of a user includes a factor weight for a given factor “A” that is expressed as the decimal value “0.2.” Assume further that a work task has the factor value “2.5” for factor “A.” In this example, the prioritization logic 134 may multiply the factor value “2.5” by the factor weight “0.2” to calculate the weighted value “0.5.” This process may be repeated to calculate weighted values for all factors associated with the work task.

In some implementations, the weighted values for all factors may be used to determine a priority score for the work task. For example, the prioritization logic 134 may sum the weighted values for all factors of a work task to calculate a priority score for the work task. Further, in some implementations, the prioritization logic 134 may order the task list 145 according to the priority scores of the included work tasks (e.g., in descending size of priority score).

In some implementations, the client device 140 may allow a user to select a work task in the task list 145 that the user wishes to begin working on. In some implementations, the user may select any work task in the task list 145 (i.e., without being limited by the position of the selected work task in the task list 145). For example, the client device 140 may include a user interface device (e.g., a touchscreen, button, keyboard, pointing device, mouse, etc.) that enables the user to select any work task that the user wishes to work on.

In some implementations, the user may select the work task based on the user's judgment as to the relative priorities of the work tasks on the task list 145. Note that the user's judgment as to relative priorities may differ from the priorities indicated by the ordering of the task list 145. As such, the user may select the work tasks in an order that is different from the order of the task list 145.

In some implementations, the profile logic 132 may update the priority profile 136 based on user selections from the task list 145. For example, assume that a priority profile 136 is used to generate a first task list 145 for a user in a first time period. Assume further that the user selects work tasks from the first task list 145 in a particular order. In some implementations, the profile logic 132 may analyze these user selections to determine or estimate the subjective importance of each priority factor for that particular user, and may update the priority profile 136 based on this information. The prioritization logic 134 may then use the updated priority profile 136 to generate a second task list 145 for the user in a second time period.

In some implementations, the profile logic 132 may update the priority profile 136 based on a regression analysis of the user selections from the task list 145. For example, the profile logic 132 may perform an ordinary least squares analysis. In some implementations, the regression analysis of a user selection “i” may be performed in accordance with the following formula:

Yᵢ+β₁X₁ᵢ+β₂X₂ᵢ+ . . . +βₖXₖᵢ+e

In the above formula, the term “Yᵢ” is a variable indicating the priority of a selected work task in a single user selection “i,” the term “β_{A}” is the factor weight for factor A, the term “X_{Ai}” is the factor value associated with factor A for user selection “i,” the term “e” is an error term, and the term “k” is the number of factors. Further, in some implementations, the regression analysis of multiple user selections may be performed according to the following formula:

Y=βX+\acute{ϵ}

In the above formula, the term “Y” is a vector including the priorities associated with N user selections, the term “β” is a vector including the factor weights for k factors, the term “X” is a matrix including factor values associated with N user selections and k factors, and the term “\acute{ϵ}” is vector including N error terms.

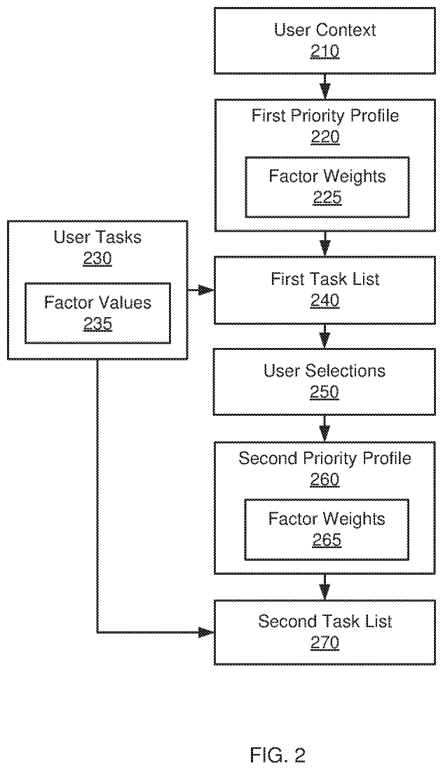

Referring now to FIG. 2, shown is an illustration of an example task list operation 200 in accordance with some implementations. As shown, the user context 210 may be used to generate a first priority profile 220. The first priority profile 220 may include a set of factor weights 225, indicating the relative priorities of multiple factors to a particular entity (e.g., a user, a work role, an organization) associated with the first priority profile 220. In some implementations, the user context 210 may specify default weights that are associated with a particular role or organization.

As shown in FIG. 2, a set of user tasks 230 and the first priority profile 220 may be used to generate the first task list 240. The first task list 240 may include a set of work tasks assigned to the particular entity. In some implementations, the set of user tasks 230 may include (or may be associated with) factor values 235. Each factor value 235 may indicate a level or score of a work task with respect to a particular priority factor. The factor values 235 and the first priority profile 220 may be used to determine priority scores for each work task in the first task list 240. In some implementations, the work tasks in the first task list 240 may be arranged according to their respective priority scores (e.g., in descending order of priority score).

In some implementations, the particular entity (e.g., one or more persons) may interact with the first task list 240 to make user selections 235. The user selections 235 may be analyzed to generate a second priority profile 260 including factor weights 265. In some implementations, the second priority profile 260 may be generated based on a regression analysis of the user selections 235. The regression analysis may be used to estimate the subjective weight of each factor for the particular entity. The second priority profile 260 and the set of user tasks 230 may be used to generate a second task list 270. In some examples, the second task list 270 may be generated after each work task in the first task list 240 has been completed by the particular entity.

Referring now to FIG. 3, shown is an illustration of an example priority profile 300 in accordance with some implementations. As shown, the priority profile 300 may include an entity identifier 310, factor weights 320, and machine learning settings 330. In some implementations, the entity identifier 310 may identify a particular user, work role, and/or organization that the priority profile 300 is assigned to.

In some implementations, the factor weights 320 may indicate the relative weights of multiple factors associated with work tasks. For example, as shown in FIG. 3, the factor weights 320 may include numeric values indicating a relative weight (e.g., 0.3) that is associated with a given factor (e.g., service impact).

In some implementations, the machine learning settings 330 may include parameter values to control the analysis of user interactions to determine or estimate a user's subjective weight for each factor. For example, the machine learning settings 330 may include a learning rate, a learning scope, and so forth.

Note that, while FIGS. 1-3 show example implementations, other implementations are possible. For example, it is contemplated that the functionality of the client device 140 may be included in the computing device 110. In another example, it is contemplated that any of the components of the client device 140 and/or the computing device 110 may be combined. In yet another example, it is contemplated that the client device 140 and/or the computing device 110 may include additional components. In yet another example, it is contemplated that the priority profile 300 may include additional fields, fewer fields. different data formats, etc. Other combinations and/or variations are also possible.

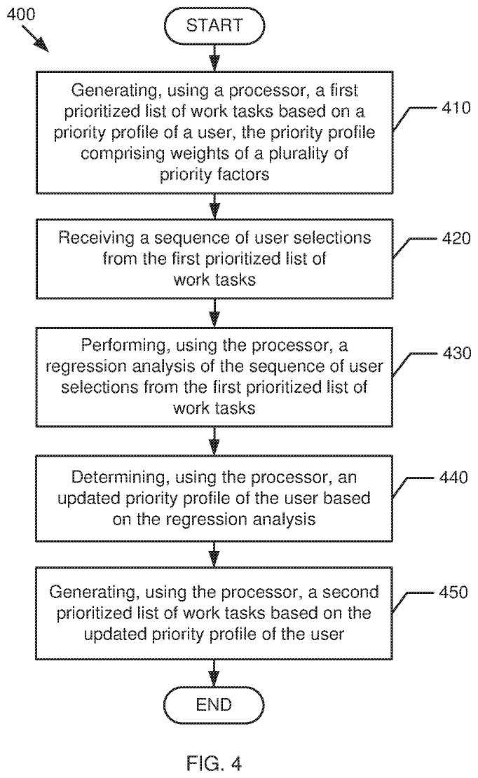

Referring now to FIG. 4, shown is an example process 400 for prioritizing a list of work tasks, in accordance with some implementations. The process 400 may be performed by the processor(s) 115, profile logic 132, and/or prioritization logic 134 shown in FIG. 1. The process 400 may be implemented in hardware or machine-readable instructions (e.g., software and/or firmware). The machine-readable instructions are stored in a non-transitory computer readable medium, such as an optical, semiconductor, or magnetic storage device. For the sake of illustration, details of the process 400 may be described below with reference to FIGS. 1-3, which show examples in accordance with some implementations. However, other implementations are also possible.

At block 410, a first prioritized list of work tasks may be generated based on a priority profile of a user. The priority profile may include weights of a plurality of priority factors. For example, referring to FIGS. 1-2, the prioritization logic 134 may generate the first task list 240 using the first priority profile 220. In some implementations, the prioritization logic 134 may also use the user tasks 230 to generate the first task list 240. In some implementations, block 410 may be performed using processor(s) 115.

At block 420, a sequence of user selections from the first prioritized list of work may be received. For example, referring to FIGS. 1-2, the profile logic 132 may receive or detect the user selections 250 in the first task list 240. In some implementations, the user selections may be received by the client device 140.

At block 430, a regression analysis of the sequence of user selections from the first prioritized list of work tasks may be performed. For example, referring to FIGS. 1-2, the profile logic 132 may perform an ordinary least squares analysis of the user selections 250 in the first task list 240. in some implementations, block 430 may be performed using processor(s) 115.

At block 440, an updated priority profile of the user may be determined based on the regression analysis (performed at block 430). For example, referring to FIGS. 1-2, the profile logic 132 may generate the second priority profile 260 based a regression analysis of the user selections 250. In some implementations, block 440 may be performed using processor(s) 115.

At block 450, a second prioritized list of work tasks may be generated based on the updated priority profile of the user. For example, referring to FIGS. 1-2, the prioritization logic 134 may generate the second task list 270 using the second priority profile 260. in some implementations, the prioritization logic 134 may also use the user tasks 230 to generate the second task list 270. Further, in some implementations, block 450 may be performed using processor(s) 115. After block 450, the process 400 is completed.

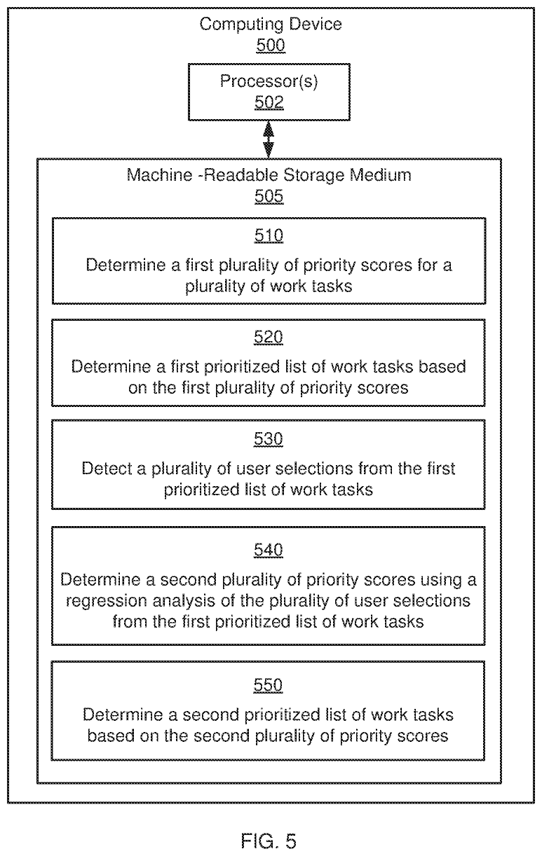

Referring now to FIG. 5, shown is a schematic diagram of an example computing device 500. In some examples, the computing device 500 may correspond generally to the computing device 110 shown in FIG. 1. As shown, the computing device 500 may include a hardware processor(s) 502 and machine-readable storage medium 505. The machine-readable storage medium 505 may be a non-transitory medium, and may store instructions 510-550. The instructions 510-550 can be executed by the hardware processor(s) 502.

Instruction 510 may determine a first plurality of priority scores for a plurality of work tasks. For example, referring to FIG. 1, the prioritization logic 134 may calculate, for each work task in the task list 145, a set of weighted values corresponding to multiple priority factors. Each weighted value may be based on a factor value and a factor weight. In some examples, the prioritization logic 134 may calculate a priority score for the work task based on the weighted values for all priority factors of the work task.

Instruction 520 may determine a first prioritized list of work tasks based on the first plurality of priority scores. For example, referring to FIG. 1, the prioritization logic 134 may order the task list 145 according to the priority scores of the included work tasks (e.g., in descending size of priority score).

Instruction 530 may detect a plurality of user selections from the first prioritized list of work tasks. For example, referring to FIGS. 1-2, the profile logic 132 may detect or otherwise determine the user selections 250 in the first task list 240.

Instruction 540 may determine a second plurality of priority scores using a regression analysis of the plurality of user selections from the first prioritized list of work tasks. For example, referring to FIGS. 1-2, the profile logic 132 may perform a least squares analysis of the user selections 250 in the first task list 240.

Instruction 550 may determine a second prioritized list of work tasks based on the second plurality of priority scores. For example, referring to FIGS. 1-2, the prioritization logic 134 may generate the second task list 270 using the second priority profile 260. In some implementations, the prioritization logic 134 may also use the user tasks 230 to generate the second task list 270.

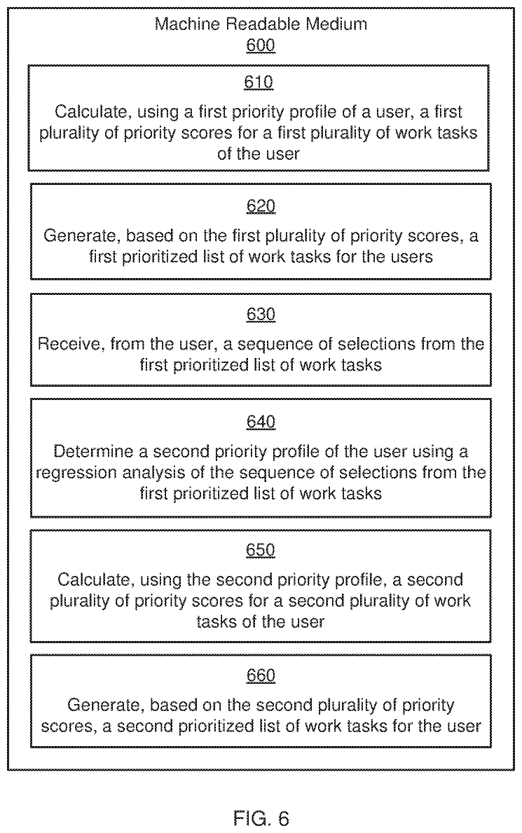

Referring now to FIG. 6, shown is a machine-readable storage medium 600 storing instructions 610-660, in accordance with some implementations. The instructions 610-660 can be executed by any number of processors (e.g., the processor(s) 115 shown in FIG. 1). The machine-readable storage medium 600 may be any non-transitory computer readable medium, such as an optical, semiconductor, or magnetic storage device.

As shown, instruction 610 may calculate, using a first priority profile of a user, a first plurality of priority scores for a first plurality of work tasks of the user. Instruction 620 may generate, based on the first plurality of priority scores, a first prioritized list of work tasks for the user.

Instruction 630 may receive, from the user, a sequence of selections from the first prioritized list of work tasks. Instruction 640 may determine a second priority profile of the user using a regression analysis of the sequence of selections from the first prioritized list of work tasks.

Instruction 650 may calculate, using the second priority profile, a second plurality of priority scores for a second plurality of work tasks of the user. Instruction 660 may generate, based on the second plurality of priority scores, a second prioritized list of work tasks for the user.

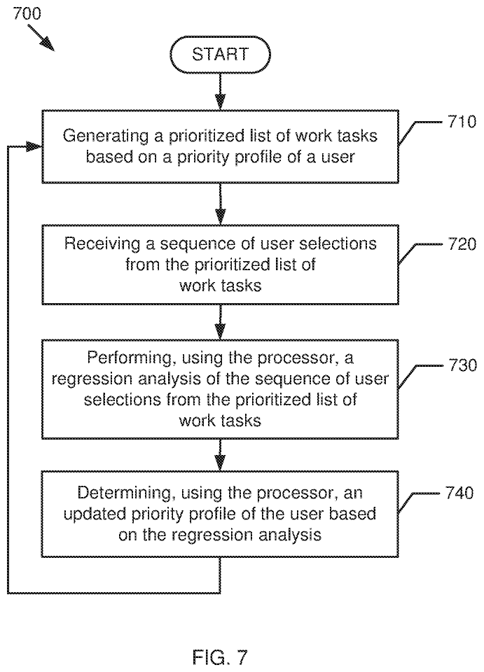

Referring now to FIG. 7, shown is an example process 700 for prioritizing a list of work tasks, in accordance with some implementations. The process 700 may be performed by the processor(s) 115, profile logic 132, and/or prioritization logic 134 shown in FIG. 1. The process 700 may be implemented in hardware or machine-readable instructions (e.g., software and/or firmware). The machine-readable instructions are stored in a non-transitory computer readable medium, such as an optical, semiconductor, or magnetic storage device. For the sake of illustration, details of the process 700 may be described below with reference to FIGS. 1-3, which show examples in accordance with some implementations. However, other implementations are also possible.

At block 710, a prioritized list of work tasks may be generated based on a priority profile of a user. At block 720, a sequence of user selections from the prioritized list of work may be received. At block 730, a regression analysis of the sequence of user selections from the first prioritized list of work tasks may be performed.

At block 740, an updated priority profile of the user may be determined based on the regression analysis (performed at block 730). After block 740, the process 700 may return to block 710 to generate a new prioritized list of work tasks based on the updated priority profile (determined at block 740). In some implementations, the process 700 may be repeated in loops as required. Thus, in some implementations, each loop of the process 700 may result in a new prioritized list of work tasks that is based on an updated priority profile of the user.

In accordance with some implementations, examples are provided for generating prioritized lists of work tasks. Some implementations include determining a set of priority scores for work tasks, and determining a prioritized list of work tasks based on the priority scores. Further, some implementations include receiving user selections from the prioritized list of work tasks, and determining a second set of priority scores using a regression analysis of the user selections. The second set of priority scores may be used to determine a second prioritized list of work tasks. In some implementations, using the second set of priority scores may provide accurate and/or useful prioritization of the list of work tasks.

Data and instructions are stored in respective storage devices, which are implemented as one or multiple computer-readable or machine-readable storage media. The storage media include different forms of non-transitory memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; optical media such as compact disks (CDs) or digital video disks (DVDs); or other types of storage devices.

Note that the instructions discussed above can be provided on one computer-readable or machine-readable storage medium, or can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

In the foregoing description, numerous details are set forth to provide an understanding of the subject disclosed herein. However, implementations may be practiced without some of these details. Other implementations may include modifications and variations from the details discussed above. It is intended that the appended claims cover such modifications and variations.

What is claimed is:

1. An article comprising a machine-readable storage medium storing instructions that upon execution cause a processor to:
calculate, using a first priority profile of a user, a first plurality of priority scores for a first plurality of work tasks of the user;
generate, based on the first plurality of priority scores, a first prioritized list of work tasks for the user;
receive, from the user, a sequence of selections from the first prioritized list of work tasks;
determine a second priority profile of the user using a regression analysis of the sequence of selections from the first prioritized list of work tasks;
calculate, using the second priority profile, a second plurality of priority scores for a second plurality of work tasks of the user; and
generate, based on the second plurality of priority scores, a second prioritized list of work tasks for the user.

2. The article of claim 1, wherein the instructions further cause the processor to:
perform the regression analysis of the sequence of selections using ordinary least squares analysis.

3. The article of claim 1, wherein the second priority profile comprises a plurality of factor weights, and wherein the instructions further cause the processor to:
calculate the plurality of factor weights based on the regression analysis of the sequence of selections.

4. The article of claim 1, wherein the instructions further cause the processor to:
for each work task of the second plurality of work tasks:
calculate a plurality of weighted values for the work task; and
calculate a priority score of the work task based on the plurality of weighted values for the work task.

5. The article of claim 4, wherein the instructions further cause the processor to:
for each of the plurality of weighted values for the work task, calculate the weighted value based on a factor value of the work task and a factor weight from the second priority profile.

6. The article of claim 1, wherein the instructions further cause the processor to:
identify, using a task database, the second plurality of work tasks as assigned to the user.

7. The article of claim 1, wherein the instructions further cause the processor to:
generate the first priority profile based on a user context of the user.

8. A method for prioritizing work tasks, comprising:
generating, using a processor, a first prioritized list of work tasks based on a priority profile of a user, the priority profile comprising weights of a plurality of priority factors;
receiving a sequence of user selections from the first prioritized list of work tasks;
performing, using the processor, a regression analysis of the sequence of user selections from the first prioritized list of work tasks;
determining, using the processor, an updated priority profile of the user based on the regression analysis; and
generating, using the processor, a second prioritized list of work tasks based on the updated priority profile of the user.

9. The method of claim 8, further comprising:
performing the regression analysis of the sequence of user selections using a least squares analysis.

10. The method of claim 8, wherein the updated priority profile comprises updated weights of the plurality of priority factors, and further comprising:
determining the updated weights of the plurality of priority factors based on the regression analysis of the sequence of user selections.

11. The method of claim 8, further comprising:
for each work task in the second prioritized list of work tasks:
determining a plurality of weighted values for the work task; and
determining a priority score of the work task based on the plurality of weighted values for the work task.

12. The method of claim 11, further comprising:
for each of the plurality of weighted values for the work task, determining the weighted value based on a factor value of the work task and an updated weight from the updated priority profile.

13. The method of claim 8, the plurality of priority factors comprising a task urgency, a level of business impact, and a response time specified in a Service Level Agreement (SLA).

14. The method of claim 8, the plurality of priority factors comprising a level of financial loss, an importance level of a task requester, and time duration since receipt of a task request.

15. A computing device comprising:
at least one hardware processor;
a machine-readable storage medium storing instructions executable by the processor to:
determine a first plurality of priority scores for a plurality of work tasks;
determine a first prioritized list of work tasks based on the first plurality of priority scores;
detect a plurality of user selections from the first prioritized list of work tasks;
determine a second plurality of priority scores using a regression analysis of the plurality of user selections from the first prioritized list of work tasks; and
determine a second prioritized list of work tasks based on the second plurality of priority scores.

16. The computing device of claim 15, the instructions further executable by the processor to:
perform the regression analysis of the plurality of user selections using ordinary least squares analysis.

17. The computing device of claim 15, the instructions further executable by the processor to:
for each work task of the second prioritized list of work tasks:
calculate a plurality of weighted values for the work task; and
calculate a priority score of the work task based on the plurality of weighted values for the work task.

18. The computing device of claim 15, the instructions further executable by the processor to:
for each of the plurality of weighted values for the work task, calculate the weighted value based on a factor value of the work task and a factor weight from a priority profile.

19. The computing device of claim 15, the instructions further executable by the processor to:
identify, using a task database, a plurality of work tasks assigned to the user; and
generate the second prioritized list of work tasks using the plurality of work tasks.

20. The computing device of claim 15, the instructions further executable by the processor to:
generate the first priority profile based on a user context of the user.
